(19) United States
(12) Patent Application Publication
(10) Pub. No.: US 2017/0286986 A1
(43) Pub. Date: Oct. 5, 2017

(54) CUSTOMER CONTROLLED INCENTIVE OFFER COMPETITION

(71) Applicant: International Business Machines Corporation, Armonk, NY (US)

(72) Inventors: Kuntal DEY, New Delhi (IN); Vijay EKAMBARAM, Tamilnadu (IN); Seema NAGAR, Bangalore (IN); Swati RALLAPALLI, Ossining, NY (US)

(21) Appl. No.: 15/089,627

(22) Filed: Apr. 4, 2016

(51) Int. Cl. G06Q 30/02; G06Q 30/06

(52) U.S. Cl. CPC G06Q 30/0224; G06Q 30/0633

(57) ABSTRACT

Systems and methods for responding to requests for offers from a shopper. A request with a list of items in which the shopper indicated an interest during a shopping visit and an identification of the shopper are received from a device associated with a shopper. Characteristics of the shopper are evaluated based on the indication of the identification. The at least one characteristic is associated with a definition of an offer to offer to the shopper. At least one offer to extend to the shopper is determined based on at least one item listed in the list of items and based on the evaluating. The at least one offer is conditioned upon a specified purchase that is associated with at least one item within the list of items. The at least one offer to the device associated with the shopper is sent based on determining at least one offer.

### BACKGROUND

The present disclosure generally relates to the field of providing purchasing incentives to shoppers and more particularly to automated systems for offering incentives from different offerors.

Manufactures, other product or service sponsors, as well as other entities, offer a wide variety of purchasing incentives to shoppers. Such incentives may cause shoppers to try new products or services and in some cases are able to cause a shopper to switch from one manufacturer or source of a product or service to another. Some incentives are able to be provided to a shopper based on previous purchases the shopper has made.

### BRIEF SUMMARY

A method at an offeror includes receiving, from a shopper's device associated with a shopper during a present shopping visit, a request including a list of items in which the shopper indicated an interest during the present shopping visit and an indication of an identification of the shopper is also received. The method further includes evaluating, based on the indication of the identification, at least one characteristic of the shopper where the at least one characteristic is associated with a definition of an offer to extend to the shopper. The method also includes determining, based on at least one item listed in the list of items and based on the evaluating, at least one offer to extend to the shopper. The at least one offer is conditioned upon a specified purchase to be made during the present shopping visit where the specified purchase is associated with at least one item within the list of items. The method further includes sending, based on determining at least one offer, the at least one offer to the shopper's device associated with the shopper. The at least one offer is valid during the present shopping visit.

In one example, a method on a shopper's device includes receiving a list of items indicated by a shopper in a present shopping visit and sending, during the present shopping visit, a request for an offer to a plurality of offerors where the request comprising the list of items. The method also includes receiving, based on sending the request, a plurality of offers where each offer is conditioned on at least one specified purchase during the present shopping visit. The method also includes receiving, during the present shopping visit, an indication of an acceptance of at least one accepted offer in the plurality of offers. A notification of the at least one accepted offer to each of the plurality of offers is sent based on the indication of the acceptance.

A processor includes a data transceiver that, when operating, receives, from a shopper's device associated with a shopper during a present shopping visit, a request that includes a list of items in which the shopper indicated an interest during the present shopping visit and an indication of an identification of the shopper. The processor also includes a request processor that when operating evaluates, based on the indication of the identification, at least one characteristic of the shopper where the at least one characteristic is associated with a definition of an offer to extend to the shopper. The request processor further determines, based on at least one item listed in the list of items and based on the evaluating, at least one offer to extend to the shopper where the at least one offer is conditioned upon a specified purchase to be made during the present shopping visit and where the specified purchase is associated with at least one item within the list of items. The data transceiver further, when operating, sends, based on determining at least one offer, the at least one offer to the shopper's device associated with the shopper, where the at least one offer is valid during the present shopping visit.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various examples and to explain various principles and advantages all in accordance with the present disclosure, in which:

FIG. 1 illustrates a retailer environment, according to an example;

FIG. 2 illustrates a retail store checkout arrangement, according to an example;

FIG. 3 illustrates a shopper's electronic device block diagram, according to an example;

FIG. 4 illustrates sponsor offer evaluation system, according to an example;

FIG. 5 illustrates a Point Of Sale (POS) block diagram, according to an example;

FIG. 6 illustrates a shopper's device process, according to an example;

FIG. 7 illustrates a retailer's system process, according to an example;

FIG. 8 illustrates an offeror's process, according to an example; and

FIG. 9 is a block diagram illustrating one example of an information processing system according to one example.

### DETAILED DESCRIPTION

The below described systems and methods allow shoppers to request to receive incentive offers, finance offers, or both, that can be applied to items they have currently selected for, or shown an interest in, purchasing. In some examples, offers extended to a shopper are also able to be based in part on information about the shopper. Such information about the shopper is able to include, but is not limited to, demographic or other profile information about the shopper, prior shopping behavior such as purchase histories or other shopping behavior, other interests demonstrated by the shopper such as can be inferred from online activities, observed activities of the shopper while using, for example, smartphone apps, other information, or combinations of these.

In some examples, the below described system and methods allow a shopper to receive competing offers from a number of offerors. For example, a shopper who has indicated an interest in a particular product, such as by placing that product in a shopping cart, looking at the product in a retailer, or by other means, is able to request offers for discounts, financing of purchases, sponsorship of purchases, or any other offer. The shopper is then able to receive a number of offers from a number of offerors. For example, a number of product sponsors are able to send offers for discounts when purchasing products related to the shopper's interest. For a particular product already selected by a shopper, one or more sponsors of that product, such as a manufacturer, distributor, other promotor, or combinations of these, are able to send one or more offers for discounts to be applied in purchasing that product. In addition to sponsors of that already selected product, sponsors of substitutes for that product, such as sponsors of a competing but similar product (e.g., a similar product with a different brand name) are also able to offer discounts or other incentives to cause the shopper to purchase the substitute product. Purchasing the substitute product is able to be in place of purchasing the already selected product by replacing the already selected product with the promoted product. The substitute product may also be purchased in some instances in addition to the already selected product. The multiple offers received by the shopper allow the shopper to consider a multitude of options regarding purchasing incentives and thereby select the most attractive offers from a range of offering entities for products the shopper has demonstrated an interest in purchasing.

In addition to incentives to purchase the already selected product and/or a substitute product, the below described systems and methods are able to be used to allow a number offerors to each extend offers for financing the purchase of products, offers to sponsor the purchase of products, or both. These systems allow a number of offerors of financing arrangement, such as credit card companies, banks, other lenders, micro-lenders, to each present their offers to the shopper and thereby allow the shopper to accept the most attractive offer(s). In addition, offerors are able to extend offers to sponsor a purchase by paying for part or all of the shopper's purchases. In an example, an offer to sponsor a purchase is able to include conditions such as marking certain purchased products with a logo or other marking selected by the offeror, or any other condition.

In an example, these requests are able to be sent during a present shopping visit to a retailer and the request is able to be based, at least in part, upon items selected by, or looked at, by the shopper during that present shopping visit. In the following discussion, a present shopping visit is able to be any shopping activity performed by a shopper within a defined area where the shopper looks at or otherwise appraises or is able to select items, products, services, or other things, to purchase and is then able to complete the present shopping activity by purchasing some or all items that were selected for purchase during the present shopping activity. Examples of present shopping visits include, but are not limited to, visiting a retail store, visiting a shopping area such as a mall or other area, visiting an online retail presence such as a retail shopping web site or in a retailer's smartphone app, other shopping activities, or combinations of these. In an example, performing an activity during a present shopping visit includes performing the activity while in the defined area and prior to completing purchasing activities of the present shopping visit, such as by a checkout process to pay for selected goods, services, or both.

Requests for such offers are able to be sent to multiple entities, such as product or service sponsors, financial institutions, other entities, or combinations of these. In an example, a shopper is able to send a list of items in which he or she has expressed an interest to one or more incentive offerors or finance offeror. This request is also able to include information allowing the offeror to evaluate the benefits or value of giving different types of incentives to that particular shopper would have for the offeror. In an example, shoppers register with one or more offerors, with a system associated with conducting the offer request and delivery process, with other registration entities, or with combinations of these. Based on receiving a request with an identification of the shopper's identity, the offeror(s) are able to retrieve information about the shopper based on, for example, the shopper's registration. In an example, the offeror(s) are able to access various types of information about the shopper. For example, a request for offers is able to include an identification of the shopper associated with the shopper's registered data and the offeror accesses the shopper's information that is provided in association with the shopper's registration. Each offeror is then able to send one or more offers to the shopper. The shopper is able to review all of the received offers and select which offers to accept. Once offers are accepted, the incentives or financial arrangements are applied to the purchase.

The below description describes systems and methods that allow a shopper to request various types of offers. In order to more clearly present aspects of the described examples discussed below, the following description depicts offers for purchasing incentives and also offers for financing arrangements. Purchasing incentive offers are generally incentives provided to shoppers to entice that shopper to purchase a particular item. In one example of an incentive, a specified benefit, such a discount, cash back, or other reward, is given to the shopper if the shopper purchases a specified item. An offer for financing arrangements are usually used to pay a retailer for a purchase and include various terms that the shopper has to follow, such as repayment terms or other actions. In the following descriptions, simplified transactions are described that include a shopper's shopping in a store and requesting offers for purchasing incentives prior to a check-out processes to purchase selected items. These purchasing incentives may cause the shopper to select other items for purchase, and may also include removing selected items to be purchased. For example, an incentive may cause a shopper to replace one brand of a product with another brand of a similar product.

After the shopper finalizes his or her purchase selections, the shopper is then able to request offers for financing arrangements for the purchase of those selected items. The request for financing arrangements offers is able to occur as part of the check-out process. It is to be understood requests for offers of purchasing incentives and financing arrangements in some circumstances are able to be made at any time and that the separation of these two requests is merely to simplify the understanding of the below described concepts.

In addition to, or in conjunction with, purchasing incentives and financing arrangements, offers for sponsorship are able to be requested by, and in some examples based on that request, extended to the shopper. Examples of entities extending offers for sponsorship include suppliers or other promoters of products from which the shopper has purchased products, the suppliers or promoters of products that are currently in stock or otherwise present in the store but are suppliers or promoters from which the shopper has not purchased products, financial institutions, the store operator, or combinations of these. In an example, the offer will specify that the offeror of a sponsorship offer will pay an agreed-upon fraction of the total cost of, for example, all of the shopper's selected items or pay some other specified amount. In exchange for this specified payment, the offeror of the sponsorship offer is able to display a logo, brand, slogan, or other marking, on specified items such as, for example, the shopper's shopping bag, some of the purchased products, on other items, or combinations of these, as may be practically feasible.

In an example, the shopper is able to initiate the process of receiving certain types of offers. In such examples, the shoppers have access to a dynamically invoked offer auction system that allows a number of offerors to each provide customers with competing offers for shopping incentives, financing arrangements, sponsorship offers, other offers, or combinations of these. In these examples, the competing offers are being provided to shoppers who have indicated present a desire to receive such offers at this time. These various offers are also able to be particularized to the shopper based on various factors, such as currently selected items, the shopper's history, other factors, or combinations of these. In an example, the shopper is able to have an electronic device that allows the shopper to cause offerors to send one or more types of offers to that shopper. The offerors will deliver these competing offers when the shopper desires to receive and select such offers, thereby making the opportunity to provide these offers more valuable to both the offeror and the shopper. In an example, the shopper is able to have a smartphone with an application program, such as an “app,” that is configured to interact with other elements of the offering process. In an example, such an “app” is able to present separate input buttons, such as graphical user interface icons, that indicate a desire to receive different types of offers.

In an example, one button or other input element that is presented to the shopper is able to be pressed or touched by a user to indicate a desire to receive offers while selecting products for purchase. Such offers are able to be purchasing incentives directed to the shopper with a goal to cause the shopper to select particular items, change a presently selected item for a similar or complementary item from another supplier, other purchasing incentives, or combinations of these. When the shopper makes this selection, a request to various offerors who are able to be chosen based on the shopper's current selected purchases, other information about the shopper, or both, are able to provide competing offers to the shopper that allows the offerors to compete against each other for the customer's purchase. This request in an example is able to include indications of the shopper's identity along with currently selected purchases such as items that are already in the shopper's current shopping cart (e.g., the set of items that the customer has already put into their shopping cart or presented to an interim checkout location). The indication of the shopper's identity is able to be used to access information about the shopper, such as demographic data, interests, purchasing histories, other information, or combinations of these, in order to better determine and evaluate offers to extend to the shopper. The offerors are then able to determine specified products that are set forth in the offer as products that the shopper has to select in order to receive benefits also specified in that offer.

In an example, the offer extended to the shopper is able to set forth specified products that are to be purchased in order to received benefits where the specified products are able to include, without limitation, products that directly compete with products the shopper's currently selected products, or products that are associated with, such as being judged to be complementary to, one or more of the shopper's currently selected products but supplied or promoted by another entity than one or more of the shopper's currently selected products. Offers requiring the purchase of such competitive products are able to be made by suppliers or promoters of such competitor products in order to cause the shopper to change his or her mind and buy the competitor's product in replacement of the currently selected product. Offers are also able to specify that certain additional products have to be purchased where those additional products are likely to be attractive to the shopper and thereby allow the sponsor to cross-selling, up-sell, up-sell, or both, based on the shopper's currently selected products. In an example, the prices of the specified products in the received offers are able to have prices that are personalized for the customer, where the personalized price is determined based on various factors as is described below.

Another button that is able to be presented on the device is able to indicate, when pressed or touched, a desire to receive offers at the checkout process. Offers provided during the checkout process are able to include offers for financing the purchase of presently selected items. In an example, financial institutions such as credit card companies whose credit cards the shopper already has, micro-loan providers, other financing companies, or combinations of these are able to receive a request for offers (which includes the list of presently selected items for purchase) and all of the recipients of that request are able to send offers back to the shopper. The shopper is then presented with all of these offers and is able to select from the presented offers which offer is to be accepted as the offer for payment. In addition to offers for financing arrangements, any other type of offer or offers are also able to be provided at or in conjunction with the checkout process.

In some examples, a shopper is able to register with an entity associated with providing offers such as offers for purchasing incentives, financing arrangements, or both, in order to provide information about the shopper that the offeror can access when a request for an offer is received. In some examples, the shopper is also able to provide in any manner information to the offerors that is related to the shoppers' characteristics in order to allow the offeror to access information about the shopper that may be relevant to determining which offers to extend to that shopper. For example, a shopper in a retail store is able to send, prior to checking out and paying for the items he or she has selected for purchase, a request to a number of sponsors for purchasing incentives. This request in an example includes a list of items the shopper has selected to purchase, and possibly identifications of items in which the shopper has expressed interest but not selected for purchase, along with identification information for the shopper. The different sponsors who receive the request are able to use the shopper's identification information to access information about the shopper in order to determine which incentives to offer the shopper. In some examples, the sponsor is able to use information about the shopper to also evaluate the benefit to the sponsor of the shopper's using particular incentives.

The value to a sponsor of offering a particular incentive is able to be evaluated in different ways. In an example, the sponsor is able to evaluate the shopper's social media presence to determine if the shopper often posts notices of recent purchases on one or more social media sites. A sponsor may want to give more valuable incentives to a shopper who often posts recent purchases because that sponsor's product is likely to receive the added exposure of such a posting. The value of the incentive the sponsor is interested in providing to the shopper may also be based on the number of social media contacts the shopper has since more social media contacts will result in more exposure for the sponsor's products. In another example, a sponsor may judge a shopper who exhibits brand loyalty to be more valuable and offer more valuable incentives to historically brand loyal shoppers, particularly if that shopper's loyalty is with a competing brand. In an example, brand loyalty of a shopper is able to be determined by, e.g., examining purchase histories of that shopper. In some examples, sponsors may determine to offer more valuable incentives to shoppers who have switched brand loyalty after redemption of a valuable incentive as could be determined by, e.g., analysis of purchase histories of that shopper.

In various examples, a shopper is able to send a request for incentives at any time while in a retailer. In some examples, a retail store is able to have equipment to monitor a shopper's interest in an item according to various acts by the shopper. In an example, a shopper's placing an item into his or her shopping cart, or even just looking at an item without placing it in the cart, is an indication of interest in the item. In the following discussion, a determination is able to be made that a shopper is indicating an interest in an item based on looking at the item by detecting any activity associated with looking at that item. For example, determining that the shopper looks at a particular item for an extended period of time, that the shopper picks an item up from a shelf and replaces the item back onto the shelf, any other indication or interest by the shopper, or combinations of these, are able to be a determination based on the shopper's looking at the item.

A retailer in an example is able to have equipment to determine what items each shopper has placed in his or her shopping cart and also include equipment to determine when a shopper has looked at an item without placing it in the cart. Determining a shopper's interest in an item in an example is able to include determining that the shopper has lifted the item from the shelf and then replaced the item back onto the shelf without placing the item into his or her shopping cart. For example, a retailer may have equipment in each shopping cart or have equipment in other locations, such as in different locations on the premises, or in any location, that is able to determine which items a shopper has placed in his or her cart or have looked at the item without placing it into the cart. Such equipment is also able to determine if the shopper has removed an item from his or her cart. In an example, an item is able to be determined to have been selected for purchase by the shopper's placing the item in his or her cart at any time during a present shopping visit. Items may be determined to be selected for purchase by being in the shopper's cart either while the shopper is moving around a retailer's store, during the checkout process to pay for and complete the purchase of selected items, or during combinations of these.

Removing an item from the cart after the shopper placed the item into the cart is able to indicate a different level of interest relative to the shopper's leaving the item in the cart. In a further example, a retailer is able to determine a shopper's interest by identifying items the shopper has picked up and looked at even if the shopper does not put the item into his or her cart. A different level of interest may be inferred by the shopper merely removing an item from the shelf and replacing it without placing it in the cart. Based on these varying levels of interest, a sponsor is able to evaluate the shopper's interest in various items and brands of those items. Sponsors are able to determine more effective incentives to offer to individuals based on these evaluations of different levels of interests.

Once the shopper sends out a request for incentives, the sponsors receiving the request are able to evaluate the information regarding the shopper and each sponsor determines one or more incentive offers to send to the shopper. The request for incentives is able to be sent to any number of sponsors. In an example, sponsors to whom the request is sent is able to be automatically determined by the process generating the request, such as a program, or “app,” on the shopper's smart phone or other electronic device. In some examples, a processor associated with the retailer is able to receive requests from the shopper's device, and the retailer's processor is then able to determine and send requests for offers to processors controlled by the various selected offerors that are to receive the request. In an example, the request for incentives is able to be sent to sponsors associated with a list of items that the shopper has presently selected to purchase or with a list of items in which the shopper has expressed interest, such as by looking at the item without placing the item into his or her shopping cart. Sponsors associated with an item are able to include not only a manufacturer or promoter of the selected item and brand, but also manufacturers, promotors, other entities, or combinations of these, that are associated with competing items or items that are complementary to those items. The selection of sponsors who receive the request is able to also be based on participation of the particular sponsor in a program promoting the incentive requests.

The sponsors receiving a request are able to extend any type of incentive offer to the requesting shopper. These offers are based on the items that the shopper has selected for purchase, and may further be based on items in which the shopper expressed interested but did not select for purchase, such as by looking at the item and not placing the item in his or her cart. Such incentive offers are able to be in any form, such as incentives to buy more of an item already selected, to buy a similar item of a brand that competes with a brand selected by the shopper, to buy an item of a brand in which the shopper indicated an interest but did not select for purchase (such as by placing in a shopping cart), any other incentive, or combinations of these. In an example, offers may be conditioned upon a specified purchase to be made during the present shopping visit whereby the shopper only receives the benefit of the offer if the specified purchase is made during the present shopping visit.

Further examples of incentives include an offer to purchase additional related items as a “one-time-offer.” Such a “one-time-offer” is able to be, for example, an item that the sponsor provides to the retail store (and an item that the retail store indicates is now in-stock). Such a “one-time-offer” is able to specify that the incentive for that item, such as a discounted price, is valid only during this shopping visit. Such a “one-time-incentive” allows a sponsor, such as a brand promotor, to cross-sell and upsell their items instantly in a physical shopping scenario. In some examples, offers for purchasing incentives may be conditioned on a specified purchase to be made during the present shopping visit. An example of a specified purchase is a purchase of one or more specified items, purchase of one or more items within a defined group of items, purchase of any defined item or service, or combinations of these.

The shopper then receives and views all of these incentive offers and determines which incentive offer(s) to accept. In an example, these offers are received and the shopper accepts them during the present shopping visit. Selection of one or more offers is able to be by an input to a smart phone or other electronic device available to the shopper. Selection of an incentive is also able to be implicitly determined by the shopper's proceeding to purchase an item that is the object of the incentive.

Once the shopper accepts one or more offers, all sponsors are provided with descriptions of the offer or offers that the shopper accepted. Providing the sponsors with descriptions of such “winning” offers allows the sponsors are able to refine their algorithms or rules for determining incentives to offer. The shopper's device is then able to provide an indication of the selected incentives to the retailer's Point of Sale (POS) system in order to have the incentives applied to the purchase total.

In some examples, once a purchase total has been determined, the shopper is able to request offers for financing offers for the purchase. In an example, the shopper is able to send requests to financing entities, such as financial institutions, micro lenders, and the like, that describes the items purchased, the cost of the purchase, and also includes an identifier of the shopper. Based on the identity of the shopper, the shopper's credit worthiness is able to be evaluated. In some examples, other characteristics of the shopper are able to be considered, such as those described above with regards to determining and evaluating the effectiveness of incentives to offer. For example, a particular financial institution may believe that a shopper who is likely to post their financing deal on social media may be of more value, so that financial institution may offer a better financing arrangement to such a shopper.

In some examples, some purchasing incentives, financial arrangement offers, or both, are able to specify that a logo or other mark is to be placed on particular purchased items as a condition for receiving the incentive. In such examples, the checkout process includes placing that logo or other mark on the specified items prior to applying the related incentive. In an example, the checkout station will have a printer or other marking device to apply such logos or markings.

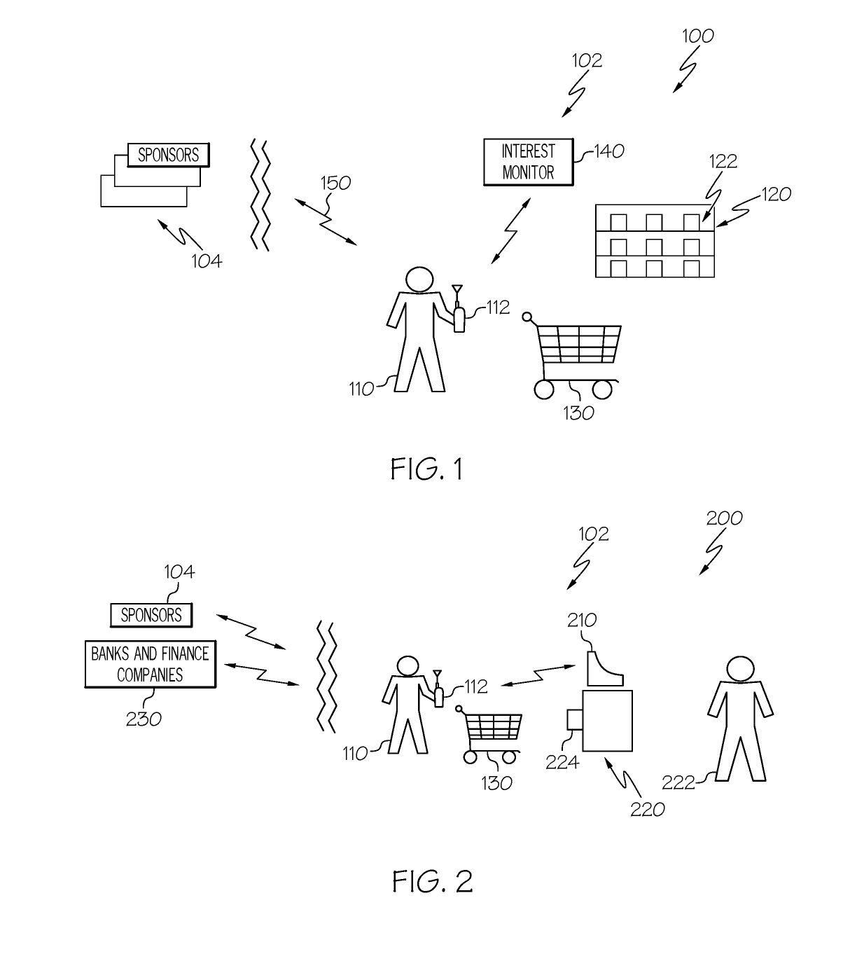

FIG. 1 illustrates a retailer environment 100, according to an example. The retailer environment 100 depicts a retailer's store 102 in which a shopper 110 is shopping for items. The shopper 110 has an electronic device 112, such as a smart phone or any other suitable device. The illustrated electronic device 112 is an example of a shopper's device that is associated with the shopper 110. In the illustrated example, the shopper is shown during a present shopping visit to a retailer's store 102. The shopper 110 at this stage of the present shopping visit moves among various store shelves 120 stocked with a variety of items 122 within the retailer's store 102 with a shopping cart 130. As a shopper 110 moves through the retailer's store 102, the shopper 110 is able to see, look at, and pick up, the items 122 on the store shelves 120. The shopper 110 is able to look at the item either while it is on the store shelves 120 or the shopper 110 is able to pick up an item to more closely look at its details. A shopper may decide to not purchase the item by, for example, either not picking up the item being look at, or by replacing the item after picking it up. The shopper is also able to decide to select the item for purchase by, for example, placing the item into the cart 130.

In an example, the retailer's store 102 includes an interest monitor 140. The interest monitor 140 in an example includes equipment to perform various functions to determine the interest of a shopper 110 in one or more items during a present shopping visit. In an example, the interest monitor 140 includes equipment to determine, e.g., if a shopper has looked at an item, has picked up an item from the store shelves 120 and then replaced it back onto the store shelves 120, if the shopper 110 has placed an item into the cart 130, if the shopper has expressed an interested in one or more items by any other technique, or combinations of these. In an example, the interest monitor 140 is able to operate with devices or equipment within the cart 130 to determine, e.g., if the shopper 110 has placed a particular item into the cart 130.

The interest monitor 140 in an example is able to assemble a list of items indicated by a shopper during the present shopping visit. This list of items is able to include, for example, some or all of the items or services in which the shopper has expressed any type of interest, such as by looking at the item, selecting the item for purchase, indicating other interests, or combinations of these. This list in some examples is able to also include other information related to those items relative to the shopper 110, such as an indication of the degree of interest in each item, such as whether the shopper 110 has merely looked at the item, placed the item into the cart 130 and subsequently replaced it back onto the store shelves 120, or if the item is presently in the cart 130.

The interest monitor 140 in an example is able to provide this list of items, along with any other related information, to the electronic device 112 of the shopper 110. The interest monitor 140 is able to send this list of items at one or multiple times during a present shopping visit. This electronic device 112 in an example is able to have suitable user interface functionality to allow the shopper 110 to review the list and to initiate a request for offers for purchasing incentives, financing arrangements, sponsorships, other offers, or combinations of these, to be sent to sponsors 104. The sponsors 104 are examples of offerors to whom requests for offers are able to be sent, and who are able to respond to such requests by sending various types of personalized offers to the electronic device 112 used by the requesting shopper 110. In an example, the electronic device 112 includes facilities to receive inputs from the shopper that allow the shopper to request, for example, offers associated with moving around the retailer while shopping and selecting items, offers associated with checking out and paying for purchase, offers associated with sponsorships of a purchase, other offers, or combinations of these. In an example, the electronic device 112 has a touch screen that is able to display graphical user interface elements, such as icons, for the various types of offers that can be requested, and the shopper 110 is able to press or otherwise indicate an input associated with one or more of these graphical user interface elements to request the particular type of offer associated with the graphical user interface element and initiate a competitive offer process by the various offerors who will receive this request.

In the illustrated example, while the shopper 110 is moving around the retailer's store 102 during the present shopping visit and has not yet started a checkout process, the shopper 110 is able to initiate a request for purchasing incentives based on the items the shopper 110 has already selected. This request in an example includes the received list of items indicated by the shopper during the present shopping visit and is sent over a data link 150 to sponsors 104 as are described below. The data link 150 is able to be any suitable data link and is able to include one or more of wired data links, wireless data links, radio links, optical links, any other communications means, or combinations of these. The data link 150 is able to send the request to any number of sponsors. In an example, the request is sent to sponsors that are selected based on items in the list of items assembled by the interest monitor 140. The request in an example is further able to include an indication of an identification of the shopper 110 in order to better support evaluation of the request by the receiving sponsors 104. Such an indication of identification is able to be in any suitable form, such as a name of the shopper 110, an identification number associated with the shopper, any information indicating identification, or combinations of these.

The sponsors 104 are able to process these requests, as is described in further detail below, and send offers of purchasing incentives to the shopper 110. The electronic device 112 receives descriptions of these offers of purchasing incentives and presents these offers to the shopper 110. In some examples, one or more of these offers are able to be conditioned upon a specified purchase. The shopper 110 is then able to indicate acceptance of these incentives by any suitable technique. In an example, the shopper 110 is able to use user interface facilities of the electronic device 112 to affirmatively indicate acceptance, such as by touching a user interface icon on a touch screen of the electronic device 112. As is described in detail below, the electronic device 112 in some examples is able send information back to the sponsors 104, such as descriptions of purchasing incentive offers that were accepted by the shopper 110. In some examples, the electronic device 112 is able to communicate to offerors through an intermediate processor, such as a processor operated by an entity associated with the system that allows the shopper to request competing offers. In an example, such an intermediate processor is able to be located within, or associated with, the retailer's store 102.

FIG. 2 illustrates a retail store checkout arrangement 200, according to an example. The retail store checkout arrangement 200 depicts an example of a shopper's checkout activities during a present shopping visit where the shopper 110 brings his or her cart 130 to a checkout stand 220 that is also located in the retailer's store 102. As is generally understood, a retailer's checkout stand 220 is a location in a retailer's store 102 where the items a shopper 110 has selected for purchase are determined and payment for those items is made. The checkout stand 220 in an example has a Point Of Sale (POS) terminal 210 that is operated by a checkout operator 222. The POS terminal 210 is able to determine the list of items selected to be purchased by a shopper 110 by any suitable technique, such as scanning bar codes or other indicia, RFID techniques, any other current or future technique, or combinations of these.

As the POS terminal 210 determines the list of items the shopper 110 has selected for purchase, the POS terminal 210 in an example is able to send the list of items selected for purchase to the electronic device 112 used by the shopper 110. The electronic device 112 in an example is able to present the list of items selected for purchase and allow the shopper 110 to select to send a request to sponsors 104 for purchasing incentives based upon this list of items that are being presently purchased. Such a request for purchasing incentives is able to be handled as described above with regard to the request sent while the shopper 110 is shopping. The electronic device 112 in an example is also able to send a request to financial institutions, such as the illustrated banks and finance companies 230, to request financing arrangements for the present purchase. This request is able to include other information, such as an indication of the shoppers identity, that are able to be used by the financial institutions receiving the request to evaluate which financing arrangement offers to extend to the shopper 110.

In an example, the sponsors 104, the banks and finance companies 230, or both, are able to respond to the requests with offers for purchasing incentives or financial arrangements, respectively. The shopper 110 is then able to indicate acceptance of one or more of these offers by any technique, such as by selecting offers presented on a screen of the electronic device 112. This acceptance in an example is during the checkout process and thus during the present shopping visit. The electronic device 112 is then able to send indications in some examples of each received offers, which of the received offers was selected by the shopper 110, other information, or combinations of these, back to the sponsors 104 and the banks and finance companies 230. The electronic device 112 is further able to send indications of the selected purchasing incentives, financing arrangements, or both, to the POS terminal 210 in order to allow the purchasing incentives, financing arrangements, or both, to be applied to the purchase transaction. In an example, the offers for purchasing incentives, financing arrangements, or both, that are sent to the electronic device 112 from the sponsors 104 or banks and finance companies are digitally signed to ensure their authenticity. In this example, the accepted digitally signed offers are then sent to the POS terminal 210 once the shopper 110 accepts those offers. The POS terminal 210 may be configured to not accept purchasing incentives, financing arrangements, or both, that are not authenticated by their offeror, such as by a digital signature.

The checkout stand 220 in an example is further able to have an item marking device/embosser 224. In some examples, one or more purchasing incentives, financing arrangements, or both, are able to require that one or more purchased items be marked, embossed, or otherwise altered in a specified manner in order to receive the benefit of the offer. In an example, the POS terminal 210 may require confirmation from the marking device/embosser 224 that the item was marked or otherwise altered as required before purchasing incentives, financing arrangements, or both, requiring such markings are applied to the purchase transaction.

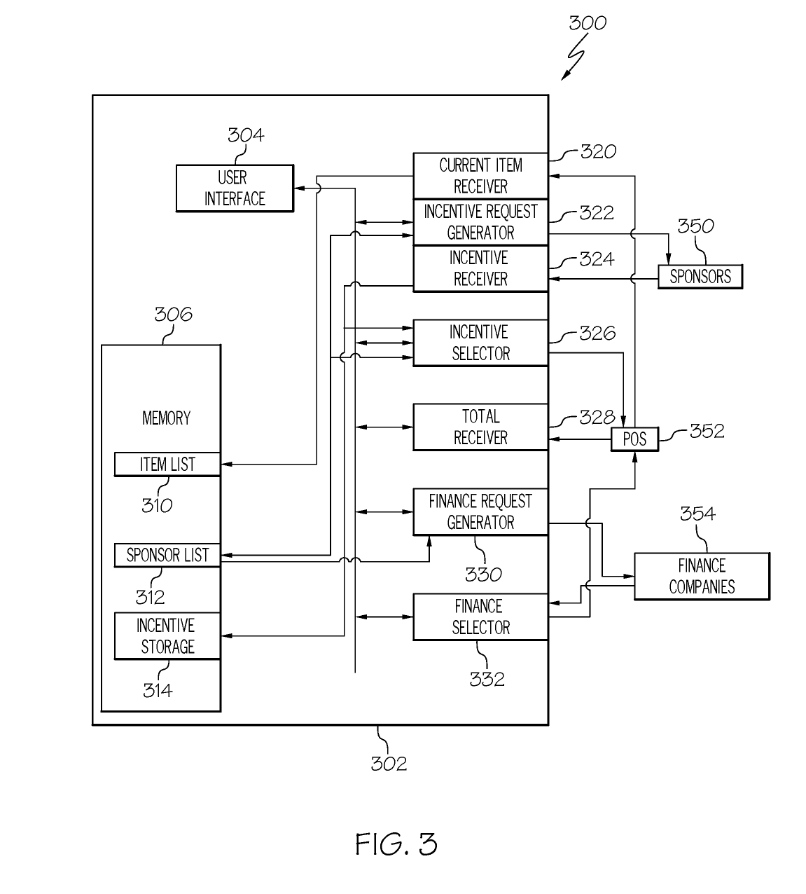

FIG. 3 illustrates a shopper's electronic device block diagram 300, according to an example. The shopper's electronic device block diagram 300 depicts an example of components contained within one example electronic device 112 used by a shopper 110, as is described above, along with depictions of other systems with which the electronic device 112 communicates and otherwise interacts.

The shopper's electronic device block diagram 300 depicts an electronic device 302. The illustrated electronic device 302 depicts processing components resident within a personal electronic device of the shopper 110, such as a smart phone or other device. The electronic device 302 includes a user interface 304 that allows a user, such as shopper 110, to interact with and control the operation of the electronic device 302. The electronic device 302 also includes a memory 306 that stores various data used by other components of the electronic device 302. In the illustrated example, the memory 306 includes storage for data including an item list 310, a sponsor list 312, and an incentive storage 314. These data are described in further detail below.

The electronic device 302 includes a current item receiver 320 that receives lists of items that the shopper has selected for purchase or in which the shopper has indicated an interest. In the illustrated example, the current item receiver receives this list from a POS system 352. As discussed above, this list is also able to be received from any interest monitor 140 as well as from a POS system 352. This received list of items is stored in an example in the item list 310. In various examples, items in the received item lists are also able to include information specifying, for example, whether an item has been selected for purchase, whether the item has been placed in the cart 130, whether the shopper 110 had picked up and replace the item from a display shelf, whether the shopper 110 had merely looked at the item, any other relevant data, or combinations of these, for some or all of the items in the list.

The electronic device 302 includes an incentive request generator 322. The incentive request generator 322 is controlled in an example by the user interface 304. In an example, when the user interface 304 indicates that a request for purchasing incentives should be sent, the incentive request generator 322 prepares a request for purchasing incentives to be sent to sponsors 350. As described above, the user interface 304 is able to provide a number of user input facilities, such as buttons, graphical user interface icons, other user inputs, or combinations of these, to allow the shopper to initiate a request for incentives. These user input facilities are able to include different buttons or other user interface input devices that each correspond to a different type of offer to request, or that are each associated with a particular phase of shopping. For example, a graphical user interface of the user interface 304 is able to have buttons to: 1) request offers or incentives to be provided while moving around the retail store 102 and selecting items to purchase; 2) requesting offers during checkout process that may include offers for financing arrangements, sponsorships, other things, or combinations of these; and/or 3) requests for any other types of offers. In an example, the request for purchasing incentives includes a list of items stored in the item list 310 as well as information identifying the shopper 110 to whom incentives are to be offered.

The incentive request generator 322 in an example determines to which sponsors the request is to be sent. In an example, the sponsor list 312 includes a list of sponsors and items that are associated with each sponsor. In an example, the request is sent to sponsors that are indicated to have associated items that are in the present list of items to be sent in the request. In an example, a sponsor may list associated items that include the sponsor's items, items that compete with the sponsor's items, items which complement the sponsor's items, items that are associated with the sponsor in any way, or combinations of these. The request for purchasing incentives is then send to the determined sponsors 350.

The sponsors 350 send purchasing incentive offers to the electronic device 302, which are received by an incentive receiver 324. The incentive receiver 324 stores the incentives in the incentive storage 314.

The user interface 304 interacts with an incentive selector 326 to allow the shopper 110 to select purchasing incentive offers that were received. The incentive selector 326 retrieves the purchasing incentive offers stored in the incentive storage 314 and presents them to the shopper 110 via the user interface 304. The user is then able to select particular purchasing incentive offers via the user interface 304. In an example, the incentive selector 326 marks those incentives as accepted in the incentive store age 314, and is able to send the accepted incentive offers to the POS system 352 upon checkout.

The electronic device 302 includes a total receiver 328 that receives information regarding the items that the shopper 110 has selected to purchase and are being processed in a checkout procedure. The total receiver 328 in an example receives a list of items being purchased and price information for the items, including an intermediate tally of the selected purchases.

The electronic device 302 includes a finance request generator 330 that receives the intermediate tally from the total receiver 328 and, under control of the user interface 304, sends a request for financing arrangements to finance companies 534. This request for financing arrangements is able to include the list of items purchased, the purchase prices, a current purchase cost that applies the purchasing incentives selected by the shopper 110, an indication of the identity of the shopper requesting the financing arrangement, other information, or combinations of these.

The electronic device 302 includes a finance selector 332 that receives financing arrangement offers from the finance companies 354. These financing arrangement offers are generally sent in response to the above described request for financing arrangement offers. The finance selector 332 operates with the user interface 304 to present the financing arrangement offers to the shopper 110 and receive indications of acceptance from the shopper for one or more financing arrangement offers. The finance selector 332 in an example send indications of the accepted financing arrangement offers to the POS system 350 in order to complete the purchase transaction.

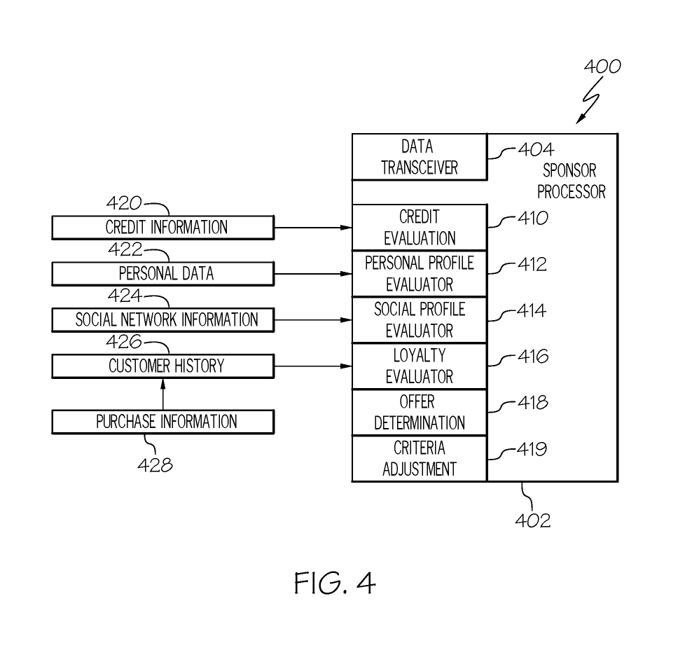

FIG. 4 illustrates sponsor offer evaluation system 400, according to an example. The sponsor offer evaluation system 400 illustrates components used to evaluate requests for offers from a shopper's electronic device, such as the above described electronic device 112 that is associated with shopper 110. The described sponsor offer evaluation system 400 depicts an example of components used by both the sponsors 104 and banks and finance companies 230 to evaluate requests for purchasing incentives or financing arrangements, respectively. In the following description, reference to an “offer” or “offers” are to be understood as offers of either purchasing incentives or financing arrangements unless described differently. The following description describes an example where electronic devices used by shoppers communicate directly with the sponsor offer evaluation system 400. In further examples, offerors such as sponsors are able to use evaluation systems that communicate with shoppers to receive requests and send offers through an intermediate processor, such as a processor associated with an entity promoting the system to provide offers to shoppers. In other examples, a single sponsor offer evaluation system 400 is also able to receive requests for multiple sponsors or offerors and determine offers based on data specified by the different offerors.

The sponsor offer evaluation system 400 includes a data transceiver 404. The data transceiver 404 in an example performs data communications with various external elements, such as shopper's devices that send requests for offers to the sponsor offer evaluation system 400 and receive offers sent by the sponsor offer evaluation system 400 to the shopper's devices. In an example, the data transceiver 404 receives a list of items in which the shopper indicated an interest during the present shopping visit. That list of items is able to be received from a shopper's device associated with a shopper during a present shopping visit. The data transceiver 404 is further able to receive an indication of an identification of the shopper. In addition to the data transceiver 404, the sponsor offer evaluation system 400 further includes a request processor that processes requests for offers. In an example, the request processor includes the below described components of an example sponsor offer evaluation system.

The sponsor offer evaluation system 400 includes a sponsor processor 402 that receives requests for offers from an electronic device used by a shopper 110. The sponsor processor 402 in an example performs an automated process to evaluate the request and determine which offers to provide to the shopper. In an example, the request for an offer includes an indication of the identification of the shopper 110, and thereby allows a personalized evaluation of which offers to extend based on characteristics of the particular shopper.

The sponsor processor 402 includes a credit evaluation processor 410. The credit evaluation processor 410 accesses a credit information store 420 to determine credit information for the requesting shopper 110. Offers for both purchasing incentives and financing arrangements are able to be based at least in part on credit information of the shopper 110.

The sponsor processor 402 includes a personal profile processor 412. The personal profile processor 412 accesses a personal data 422 to determine information about the shopper relative to the received request for offer. In an example, prior purchases by the shopper, hobbies of the requesting shopper, the type of job the shopper has, are examples of data stored in the personal data 422 that are able to influence the evaluation of incentives to provide to the requesting shopper.

The sponsor processor 402 includes a social profile processor 414. The social profile processor 414 accesses social network information 424 to determine social network activities of the requesting shopper 110. For example, the propensity of the requesting shopper 110 to post recent purchases or other purchasing activities on social media outlets may influence which offers to extend to the requesting shopper 110.

The sponsor processor 402 includes a loyalty evaluator 416. The loyalty evaluator 416 accesses customer history information 426 to determine the likelihood that the requesting shopper 110 will be brand loyal and therefor provide a better return to the offeror for a given offer. In an example, customer history 426 is able to include purchase information 428 that describes purchasing habits of the requesting customer. In an example, the purchase information 428 is able to include purchase history or financing history information along with offer acceptance information to evaluate the affect particular offers had on purchasing habits of the requesting shopper.

In an example, the above described evaluations are based on a first set of criteria upon which at least one characteristic of the shopper is to be evaluated. In addition to the above described evaluations, the sponsor offer evaluation system 400 further includes an offer determination processor 418 that, in one example, evaluates the list of items in which the shopper indicated an interest that was received in the request. This list is examined with respect to a second set of criteria upon which at least one offer is determined. The at least one offer is based upon at least one item in the received list of items. In an example, extended offers are able to be conditioned upon a specified purchase, be valid only during the present shopping visit, be conditioned upon anything, or be conditioned on combinations of these.

The sponsor offer evaluation system 400 in an example further includes a criteria adjustment processor 419. The criteria adjustment processor 419 receives and analyzes descriptions of other offers that were extended by other offerors to shoppers based on the shopper's request, such as shopper's requests for offers that were also received by the sponsor offer evaluation system 400. These offers by other offerors are compared in an example to the sets of criteria used by the sponsor offer evaluation system 400. In an example, the criteria adjustment processor 419 is able to modify, based on the description of other offers, at least one of the above described first set of criteria or the second set of criteria.

The illustrated sponsor offer evaluation system 400 in an example is able to operate with a communications controller that receives requests for offers from shoppers as is described above in relation to the data transceiver 404. In an example, that communications controller then sends those received requests for offers to each offeror within a number of various other offerors. These various other offerors are able to be competitors with one another, operate in concert with one another, or have any type of relationship with one another. After the communications controller sends the request for offers to each offeror, the communications controller is able to receive one or more competing offers from one or more of the other offerors to which the request was sent. In general, these competing offers are able to provide any incentive, financing arrangement, sponsorship offer, other offer, or combinations of these. The allowing these multiple other offerors to each submit offers in response the shoppers request for offers creates an environment where these multiple other offerors are able to “bid” with incentives or other benefits for the shopper in order to cause the shopper to patronize or otherwise select promotions promulgated by those offerors.

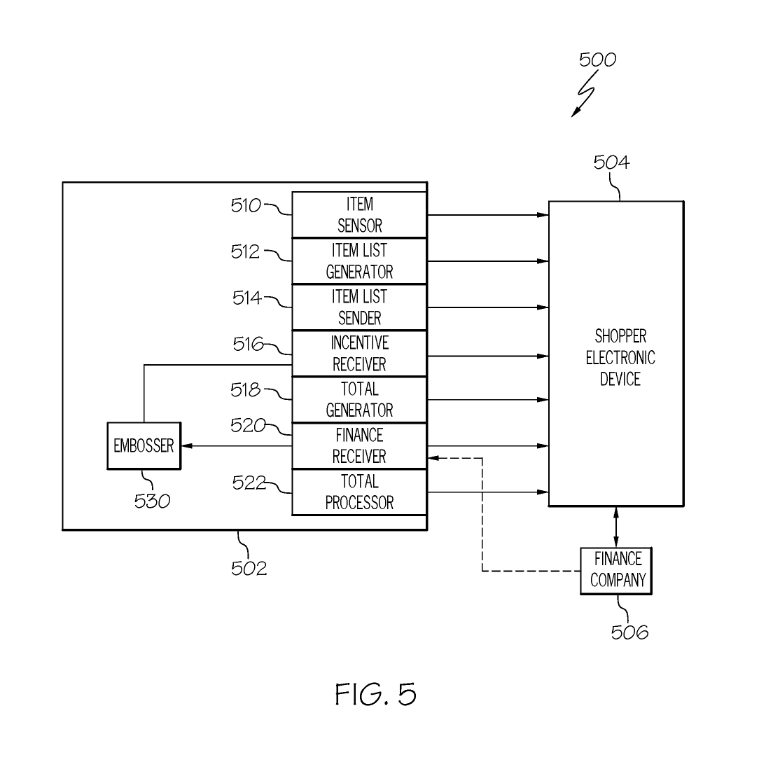

FIG. 5 illustrates a Point Of Sale (POS) block diagram 500, according to an example. The Point Of Sale (POS) block diagram 500 depicts an example of components within a checkout stand 220 and components with which the checkout stand 220 communicates.

The Point Of Sale (POS) block diagram 500 depicts a Point Of Sale terminal 502 that includes a number of processing components. The illustrated Point Of Sale terminal 502 determines items a shopper 110 has selected for purchase, exchanges a list of these determined items with an electronic device used by the shopper, receives indications of purchasing incentives and financing arrangements selected by the shopper and applies those to the purchasing transaction.

The Point Of Sale terminal 502 includes an item sensor 510 that determines all of the items the shopper 110 has selected for purchase. The item sensor 510 is able to use any technique to determine the items such as a bar code reader, any other present or future item sensor, or combinations of these.

The Point Of Sale terminal 502 includes an item list generator 512. The item list generator 512 receives the items determined by the item sensor and formats a list of items. In an example, this list of items is provided to an item list sender 514. The item list sender 514 sends this list in an example to a shopper electronic device 504. In an example, the shopper electronic device manages obtaining and accepting purchase incentive offers from various sponsors, as is described above.

The Point Of Sale terminal 502 has an incentive receiver 516 that receives indications of purchasing incentives from the shopper electronic device 504. In some examples, the received purchasing incentives have been accepted by the shopper from a number of offers. The received purchasing incentives are able to require that certain purchased items are to be marked, embossed, or otherwise altered in order to fulfill the conditions of the offer. In such cases, the required marking, embossing, other alteration, or combinations of these, are made by an embosser 530. The incentive receiver 516 in some examples provides a description of the required marking, embossing, other alternation, or combinations of these, to the embosser 530.

The Point Of Sale terminal 502 includes a total generator 518 that determines the total price of the items selected for purchase, and applies the selected purchasing incentives to this total. This total, adjusted by the applied purchasing incentives, is provided to the shopper electronic device 504. The shopper electronic device 504 in an example manages requests and shopper acceptance of financing arrangement offers for the purchase, as is described above.

The Point Of Sale terminal 502 includes a finance receiver 520 that receives details of financing arrangements that were accepted by the shopper. The finance receiver 520 provides these financial arrangements to a total processor 522 so that they can be applied to the purchase. In some examples, a financing arrangement may require marking, embossing, otherwise altering, or combinations of these, of a purchased item. In such cases, the finance receiver 520 provides a specification of the required marking, embossing, alteration, or combination thereof, to the embosser 530.

In some examples, the Point Of Sale terminal 502 is able to authenticate purchasing incentives, financing arrangements, or both. Applying these purchasing incentives, financing arrangements, or both, in some examples may be conditioned on their successful authentication. In some examples, purchasing incentives, financing arrangements, or both, that require marking, embossing, other alteration, or combinations of these, of an item are only applied upon confirmation of such marking, embossing, alteration, or combination thereof.

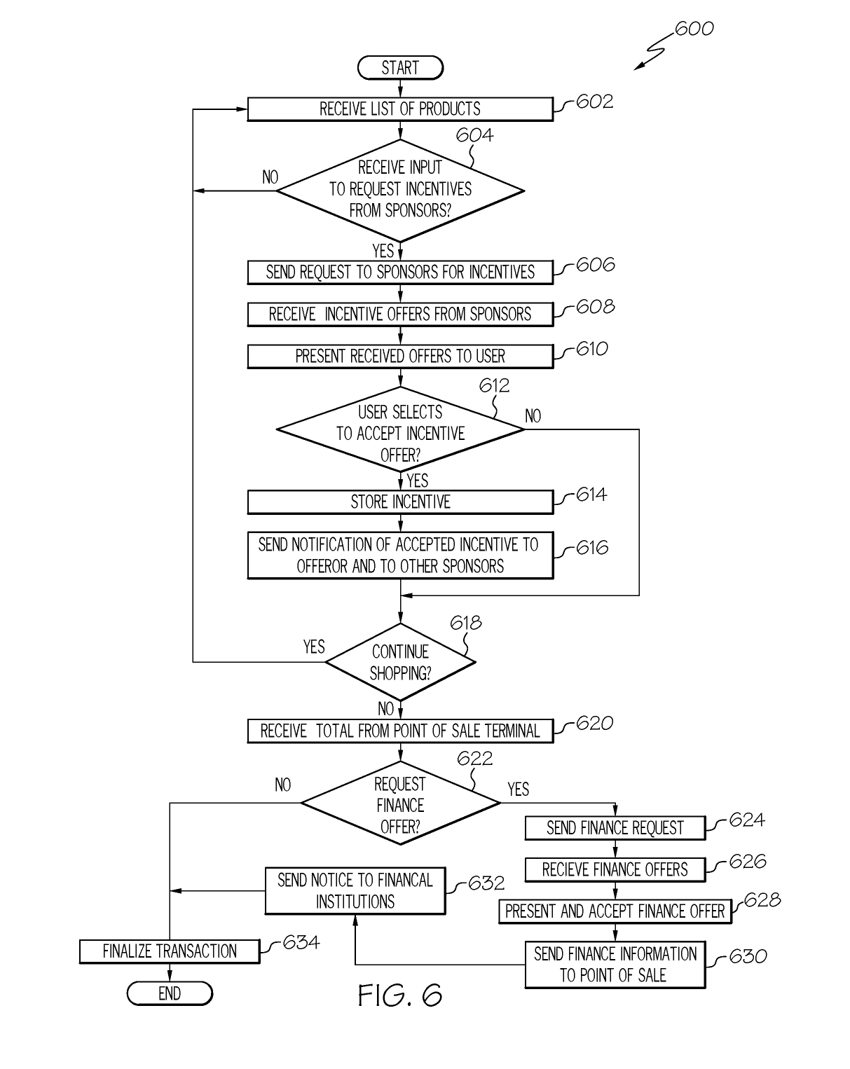

FIG. 6 illustrates a shopper's device process 600, according to an example. The shopper's device process 600 is an example of processing performed by a shopper's device, such as the electronic device 112 operated by a shopper 110 as is described above. In an example, the shopper's device process 600 is entirely performed during a single present shopping visit by the shopper to a retailer's store.

The shopper's device process 600 beings by receiving, at 502, a list of item. This list of items is able to be a list determined at any time during a shopper's visit to a retailer. In one example, the list of items is able to be received from a POS terminal during the checkout process as is described above. In another example, the list of items is able to be received prior to checkout while the shopper is moving around the retailer's store. The list of items is able to list items in which the shopper has indicated various levels of interest. For example, a list of items is able to include items that the shopper has placed in the shopper's cart and in some examples is also able to include items in which the shopper has indicated an interest, for example, by looking at for an extended period of time, by removing from a shelf and then replacing onto the shelf, by any other action, or by combinations of these.

The shopper's device process 600 continues by determining, at 604, if input has been received to request incentives from sponsors. As described above, a shopper's electronic device is able to have a user interface that allows a user to provide an input to cause a request to be sent to sponsors for purchasing incentives. Such input in further examples is able to be received from any source, including automated processes. If no such input is determined to be received, the shopper's device process 600 returns to receiving, at 602, a list of items. In an example, iterations of receiving lists of items are able to cause updated lists of items to be received as the shopper moves about the retail store and selects or otherwise demonstrates interest in more items.

If input is received to request incentives, the shopper's device process 600 sends, at 606, a request for incentives to one or more sponsors. As is discussed above, the sponsors that are selected to receive a request for incentives are able to be selected based on any suitable basis. In an example, a request is able to be sent to sponsors that have specified they are interested in offering incentives to shoppers who have selected or shown an interest in one or more items on the list of items. In some examples, requests are able to be sent to all sponsors without any regard to items on the list of items. In some examples, the request includes the received list of items. Identification of the shopper for whom the incentives are being requested is also included in the request in some examples.

The shopper's device process 600 receives, at 608, incentive offers from one or more sponsors. These incentive offers are generally received based on the request that was sent to these sponsors. The incentives are able to offer any benefit to the shopper, such as a discounted price or other reward, in return for the shopper's performing specified activities such as purchasing one or more specified items. In some examples, the received incentive offers include, for example, a digital signature to allow the offer to be authenticated as originating from its indicated source. In some examples, the received incentive offers are able to include a number of purchasing incentives that include purchasing incentives that are from a number of different offerors, such as from different product brands, different sponsor of the same or different products, from any different sponsors, or combinations of these.

The received incentive offers are presented, at 610, to a user of the shopper's device. The presentation is able to include a description of the benefit provided by the incentive, what the shopper is required to do to receiver the benefit, any other conditions associated with the offer, or combinations of these. The presentation of the offer is also able in some examples to include a user interface element, such as an “accept” button on a touch screen display, that allows the user of the shopper's device to indicate acceptance of a particular offer.

The shopper's device process 600 determines, at 612, if the user selects to accept one or more incentive offer. If the user did not select to accept an incentive offer, the shopper's device process 600 proceeds to determine, at 618, whether the shopper continues shopping and the further processing described below. If it is determined that the user selects to accept an incentive offer, at 612, the shopper's device process 600 stores, at 614, an indication of the incentive. In some examples, the received offer for the incentive is stored in the shopper's device.

The shopper's device process 600 proceeds to send, at 616, notifications of accepted incentives to the offeror of the accepted incentive offer and also to the other sponsors. In various examples, this notification includes a description of the offers that were accepted by the shopper. In some examples, the notification also includes descriptions of all offers that were extended to the shopper.

After sending the notification, at 616, or if it is determined that the shopper did not select to accept an incentive offer, at 612, the shopper's device process 600 determines, at 618, if the shopper is continuing shopping. This determination in an example is based upon a determination as to whether the shopper is checking out and making purchases, or if the shopper is still moving within the retail store. If it is determined that the shopper is continuing shopping, such as by still moving within the retail store, the shopper's device process 600 returns to receiving, at 602, a list of items and with the above described subsequent processing.

If it is determined, at 618, that the shopper is not continuing shopping, such as by checking out and making purchases of selected items, the shopper's device process 600 receives, at 620, a total from the Point Of Sale (POS) terminal. This total will indicate the final list of items that the shopper is purchasing along with their prices and total purchase cost. In an example, incentives that were selected by the shopper will be applied to the total, such as discounted prices or other benefits that can be provided by the retailer at checkout.

A determination is made, at 622, as to whether financing arrangement offers are to be requested. In an example, a shopper is able to use the user interface of the shopper's device to indicate during the checkout process that the shopper wishes to receive financing offers.

If it is determined that the shopper requests that financing arrangement offers be requested, the shopper's device process 600 proceeds to send, at 624, financing offer requests. These requests are able to include, for example, a list of items purchased, information identifying the shopper for which financing arrangement offers are being requested, other information, or combinations of these. Financing institutions that receive these requests are able to be selected by any suitable techniques. In some examples, financing institutions with which the shopper is already doing business are included in the recipients of this request. Other recipients are able to be selected based upon any suitable criteria.

Financing arrangement offers are received, at 626, from various financial institutions. Such financing offers will specify terms for the financing and may also specify other actions that are required by the shopper to receive the financing arrangement. For example, the offer may specify that one or more items being purchased are to be marked, embossed, otherwise altered, or combinations of these, in order to receive the offered financing arrangement. As is described above with regards to the incentives sent to the shopper, offers for financing arrangements are also able to be authenticated by, for example, a digital signature with is applied the offer data sent to the shopper's device. In some examples, the received offers for financing arrangements are able to include a number of offers for financing arrangements that are from a number of different offerors, such as from different banks, credit card companies, micro-lenders, other financing entities, any other entities or combinations of these. In some examples, receiving financing arrangements is also able to include receiving one or more offers to pay for at least part of a purchase of items.

The received financial arrangement offers are presented to the shopper, at 628, at which time the shopper is able to select to accept one or more of the received offers. The presentation of offers to the shopper and receipt of acceptance of one or more offers in one example uses the user interface of the shopper's device. In an example where the shopper does not accept a financing arrangement offer, the checkout process continues without applying a financing arrangement.

The accepted financing arrangement information is sent, at 630, to the Point Of Sale (POS) terminal so that it can be applied to the present purchase. As discussed above, this information is able to include information to allow authentication of the offer by, for example, a digital signature that was applied by the offeror.

A notice of the accepted financing arrangement offer is sent, at 632, to all offerors of financing arrangements. In various examples, a description of the selected offer, a respective description of all offers sent to the shopper, other information, or combinations of these are able to be included in this notice.

After sending the notice of the accepted offer, or after determining that the financing arrangement offers were not requested, at 622, the purchase transaction is finalized, at 634. Finalizing the purchase transaction is able to include any actions by the shopper, retailer, or both, such as providing payment, further information, any other action, or combinations of these. The shopper's device process 600 then ends.

The above described example describes an operation where purchasing incentives are received during shopping in the retailer or at other times of the shopping visit, and financing arrangements are received at an event such at the checkout process of a shopping visit. In various examples, any type of offer, including any combination of any number of offers, is able to be received at any time. For example, during shopping in the store, a combination of different types of offers is able to be received that includes not only purchasing incentives but also one or more of financing incentives, offers to pay for at least part of the customer's purchases, or other types of offers. Additionally, a customer is also able to receive a combination of different types of offers at checkout.

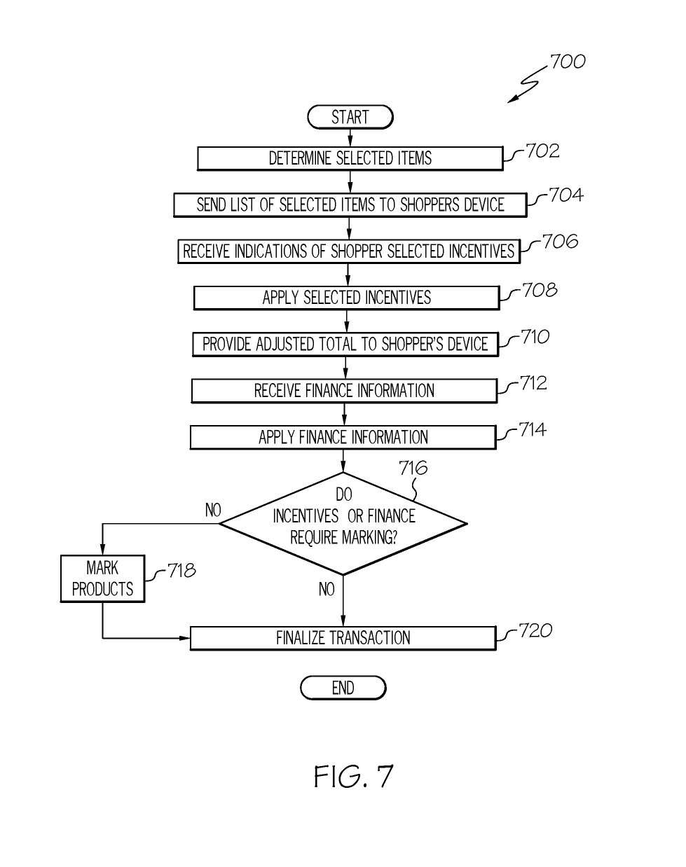

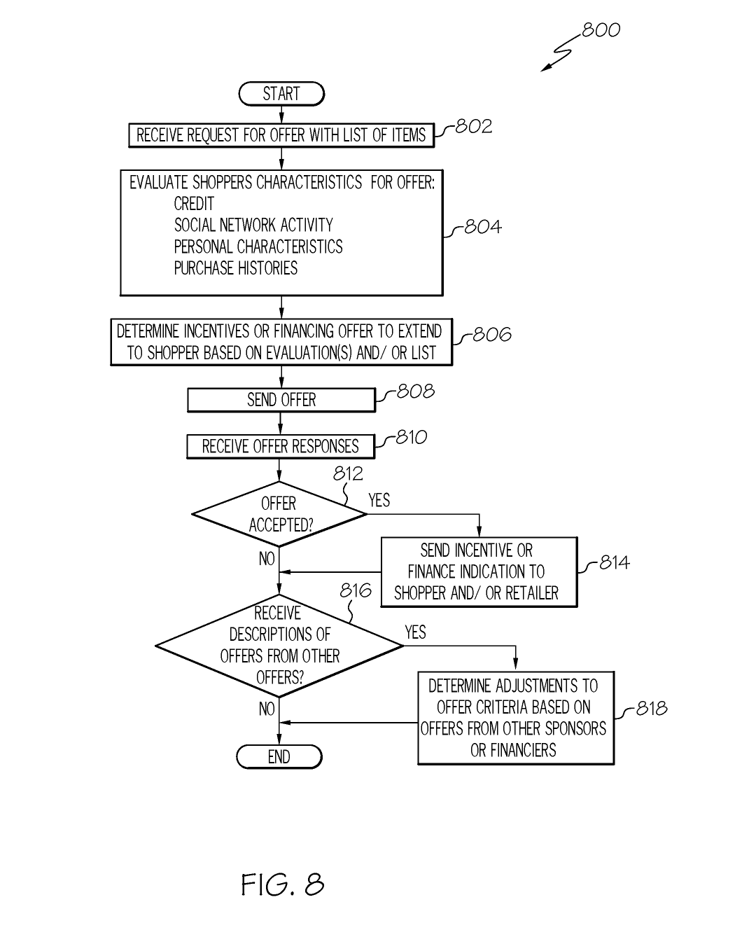

FIG. 7 illustrates a retailer's system process 700, according to an example. The retailer's system process 700 is an example of a process performed by processors associated with a retailer. For example, the retailer's system process 700 is able to be performed by a Point Of Sale (POS) terminal 210 in a retailer as is described above, during a checkout process. It is further clear that part or all of the below described retailer's system process 700 is also able to be performed in association with an interest monitor 140 while the shopper is shopping in a retailer as is described above, in association with any other retailer equipment or processing, or with combinations of these.

The retailer's system process 700 begins by determining, at 702, items that the shopper has selected. In various examples, these items are able to include items the shopper has placed into a cart for purchase, items in which the shopper has expressed an interest such as by looking at the item, other items indicated in any manner by the shopper, or combinations of these. This determination is able to be made by a POS terminal at checkout by, for example, scanning bar codes. In further examples, this determination is able to include observations by an interest monitor 140 as is described above.

The retailer's system process 700 sends, at 704, a list of items that the shopper selected to the shopper's device. This list is able to be communicated by any suitable technique, such as by short range wireless data links, longer range data links, any data link, or combinations of these.

The retailer's system process 700 receives, at 706, indications of shopper selected purchasing incentives. In an example, the shopper's device, as is described above, is able to perform processing to request, receive, and allow the shopper to select purchasing incentives. The purchasing incentives selected by the shopper are then sent to the POS terminal, and received by the POS terminal at this stage.

The retailer's system process 700 applies, at 708, the purchasing incentives selected by the shopper. The selected purchasing incentives are able to specify, for example, discounted prices, other benefits to the shopper, other actions, or combinations of these. The selected purchasing incentive is also able to include actions to be performed by the retailer as part of applying the purchasing incentive, such as applying markings, embossing, other alterations, or combinations of these, to one or more purchased items.

The after the selected incentives are applied to the purchasing total, the retailer's system process 700 provides, at 710, an adjusted total to the shopper's device. This adjusted total will apply any discounts or other financial benefits that are associated with accepted purchasing incentive offers to the present purchase.

Financing arrangement information is able to be received, at 712. As discussed above, the shopper's device is able to perform processing by which the shopper is able to request, receive, and accept offers for financing arrangements for the present purchase. The shopper's device is then able to send information describing the selected financing arrangement offer the POS terminal. In some examples, the received information about the accepted financing arrangement is able to be authenticated, such as by a digital signature, to ensure that the financing arrangement offer originated from the proper financial institution.

The financial arrangement is then applied, at 714. Applying the financial arrangement is able to include, for example, arranging to receive payment from the financial institution that offered the financing arrangement.

A determination is made, at 716, as to whether any of the accepted purchasing incentives, financing arrangement, or both, requires marking, embossing, or other alteration, to any of the purchased items. As described above, certain purchasing incentives or financing arrangements may require some purchased items to have a logo or other marking or alteration applied to an item in order to promote the offeror.

If it is determined that marking, embossing, other alteration, or combinations of these is required, the item is so marked, embossed, otherwise altered, or combinations of these, at 718. After marking, embossing, otherwise altering, or combinations of these, or if the selected purchasing incentives do not require such actions, the transaction is finalized, at 720. Finalization of the transaction is able to include any action, such as receiving some payments from the shopper, presenting a receipt or other documentation to the shopper, any other action, or combinations of these.

FIG. 8 illustrates an offeror's process 800, according to an example. The illustrated offeror's process 800 is an example of processing that is able to be performed by ether an item sponsor to determine purchasing incentives to offer a shopper, or processing that is performed by a bank or other financial institution to determine financing arrangements to offer to the shopper.

The offeror's process 800 begins by receiving, at 802, a request for an offer, where that request includes list of items from a shopper where those items were selected or otherwise notice by the shopper. In an example, this request is able to be an offer for either purchasing incentives or for financing arrangements for a purchase being made from the requesting shopper. This request in an example includes an identification of the shopper making the request so as to support evaluation of relevant characteristics of the shopper in determining which offers to extend. In an example, this request or similar requests are sent to a number of offerors which are each able to send the shopper one or more offers from which to choose and accept.

The offeror's process 800 evaluates, at 804, the shopper's characteristics with respect to the offer to be extended to the shopper. As is described above, an offer for either purchasing incentives or financing arrangements is able to be based on information about the shopper regarding the shopper's credit, social network activities, personal characteristics, purchase histories, other characteristics, or combinations of these.

Purchasing incentives or financing offers to extend to the shopper are determined, at 806, based on the evaluation(s) of the shopper's characteristics, the list of items received with the request, or both. In an example, each offeror is able to define rules and guidelines for automated evaluation of shopper characteristics, current lists of items, other factors, or combinations of these, upon which to base an offer to extend to the shopper.

The determined offer is then sent, at 808, to the shopper's device. In an example, the offer includes information to authenticate the origin of the offer, such as a digital signature of the offer data.

After the offer or offers are sent to the requesting shopper, the shopper is able to select to accept one or more of the offers the shopper receives. The offeror's process 800 in an example is able to receive, at 810, responses to the offers that were sent to the shopper's device. In an example, the responses are able to include an indication of an acceptance of the offer sent to the shopper's device. This indication of acceptance is able to cause the offeror to prepare to perform the benefits extended in the offer, and to memorialize the shopper's acceptance of the offer.

A determination is made, at 812, as to whether this offeror's offer was accepted. If it is determined that this offeror's offer was accepted, in some examples an indication of the incentive or financing arrangement is sent to the shopper's device, the retailer, or both. In further examples, the offeror does not communicate with the retailer and the shopper's device provides all indications of the purchasing incentive or financing arrangement. This indication is able to include a confirmation that is sent to the shopper of the purchasing incentive or financing arrangement that the shopper has accepted.

After the shopper selects to accept one or more offers, the shopper's device is able to send to some or all of the offerors a notice of which offer or offers were received. This notice is able to be sent as part of the offer responses that are received at 810. This notice is also able to be received in a separate transmission sent at any time after the shopper accepts one or more offers.

A determination is made, at 816, if descriptions of offers from other offerors have been received. In various examples, this notice is able to include descriptions of the offer or offers that were accepted by the shopper, descriptions of all offers received by the shopper, other information, or combinations of these.

If it is determined that descriptions of offers from other offerors were received, adjustments to the offer criteria used by this sponsor are able to be determined based on the received descriptions of offers made by other offerors and also by observation of which offer or offers were accepted by the shopper. In various examples, these adjustments may be applied to the criteria for determining offers to extend to all shoppers, to the particular shopper to whom this offer was extended, to shoppers judged to be similar to this particular shopper, or to criteria for any group of shoppers. Different adjustments based on this information are also able to be made to different criteria that are each used for a different group of shoppers. The offeror's process 800 then ends.

The above examples describe a scenario of a shopper shopping in a retail store. It is clear that the above described systems and methods are also easily adapted to be implemented in any type of retail or commercial environment. For example, similar processing is able to be performed in conjunction with on-line shopping experiences. Further, the above concepts are easily extended to any vending scenario involving a buyer purchasing objects or services that are able to have multiple sponsors, for which financing is able to be sought from multiple sources, or combinations of these.

### Information Processing System

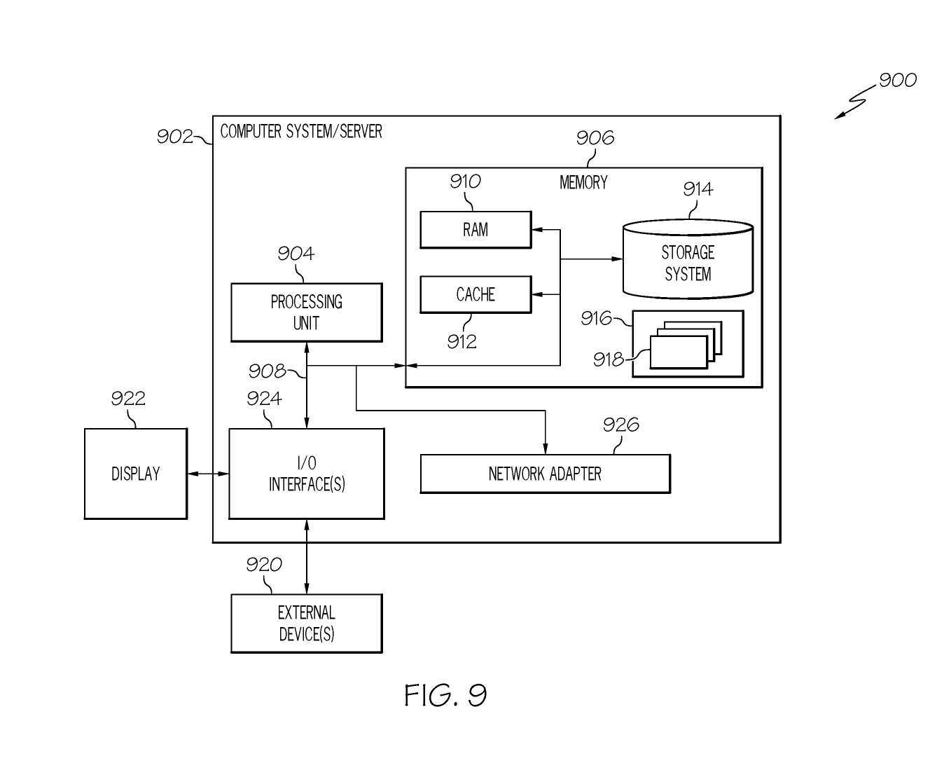

Referring now to FIG. 9, this figure is a block diagram illustrating an information processing system that can be utilized in various examples of the present disclosure. The information processing system 902 is based upon a suitably configured processing system configured to implement one or more embodiments of the present disclosure. Any suitably configured processing system can be used as the information processing system 902 in embodiments of the present disclosure. In another embodiment, the information processing system 902 is a special purpose information processing system configured to perform one or more embodiments discussed above. The components of the information processing system 902 can include, but are not limited to, one or more processors or processing units 904, a system memory 906, and a bus 908 that couples various system components including the system memory 906 to the processor 904.

The bus 908 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 906 can also include computer system readable media in the form of volatile memory, such as random access memory (RAM) 910 and/or cache memory 912. The information processing system 902 can further include other removable/non-removable, volatile/non-volatile computer system storage media. By way of example only, a storage system 914 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 908 by one or more data media interfaces. The memory 906 can include at least one program product having a set of program modules that are configured to carry out the functions of various examples described above.

Program/utility 916, having a set of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of the above described processes and systems.

The information processing system 902 can also communicate with one or more external devices 920 such as a keyboard, a pointing device, a display 922, and the like. The information processing system 902 is further able to communicate with one or more devices that enable a user to interact with the information processing system 902; and/or any devices (e.g., network card, modem, etc.) that enable computer system/server 902 to communicate with one or more other computing devices. Such communication can occur via I/O interfaces 924. Still yet, the information processing system 902 can communicate with one or more networks such as a local area network (LAN), a general wide area network (WAN), and/or a public network (e.g., the Internet) via network adapter 926. As depicted, the network adapter 926 communicates with the other components of information processing system 902 via the bus 908. Other hardware and/or software components can also be used in conjunction with the information processing system 902. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method at an offeror, the method comprising:
receiving, from a shopper's device associated with a shopper during a present shopping visit, a request for an offer, the request comprising a list of items in which the shopper indicated an interest during the present shopping visit and an indication of an identification of the shopper;
evaluating, based on the indication of the identification, at least one characteristic of the shopper, the at least one characteristic being associated with a definition of an offer to extend to the shopper;
determining, based on at least one item listed in the list of items and based on the evaluating, at least one offer to extend to the shopper, the at least one offer being conditioned upon a specified purchase to be made during the present shopping visit, the specified purchase being associated with at least one item within the list of items; and
sending, based on determining at least one offer, the at least one offer to the shopper's device associated with the shopper, the at least one offer being valid during the present shopping visit.

2. The method of claim 1, wherein the offer comprises an offer for at least one of a purchasing incentive, a financing arrangement, and a sponsorship comprising an offer to pay a specified portion of a purchased by the shopper during the present shopping trip.

3. The method of claim 1, further comprising:
maintaining a first set of criteria upon which the at least one characteristic is to be evaluated;
maintaining a second set of criteria upon which the at least one offer is determined based upon at least one item in the list of items;
receiving, based on the sending, a description of other offers sent by other offerors to the shopper's device, the other offers being based on the list of items and the indication of the identity of the shopper; and
modifying, based on the description of the other offers, at least one of the first set of criteria or the second set of criteria.

4. The method of claim 1, wherein the at least one offer is valid only during the present shopping visit.

5. The method of claim 1, wherein the at least one characteristic comprises one or more of social media activity, shopping history, or personal characteristics.

6. The method of claim 1, wherein at least one offer comprises specifying that at least one specified purchased item be at least one of marked, embossed, or altered.

7. The method of claim 1, wherein the at least one offer comprises an offer that is conditioned on a purchase of a specified item that is not in the list of items.

8. The method of claim 1, wherein the list of items is generated as part of a checkout process and the list of items comprises a list of items the shopper has selected for purchase.

9. The method of claim 1, wherein the at least one offer comprises an offer that is conditioned on a purchase of a specified item that competes with or is associated with at least one item in the list of items.

10. The method of claim 1, further comprising:
sending, based on receiving the request for an offer, the request to each respective offeror within a plurality of offerors; and
receiving, based on sending the request to the plurality of offerors, a plurality of competing offers, the plurality of competing offers comprising a respective competing at least one offer from each respective offeror within the plurality of offerors, and
wherein the sending the at least one offer further comprises sending the plurality of competing offers to the shopper's device.

11. A method on a shopper's device, the method comprising:
receiving a list of items indicated by a shopper in a present shopping visit;
sending, during the present shopping visit, a request for an offer to a plurality of offerors, the request comprising the list of items;
receiving, based on sending the request, a plurality of offers, each offer being conditioned on at least one specified purchase during the present shopping visit;
receiving, during the present shopping visit, an indication of an acceptance of at least one accepted offer in the plurality of offers; and
sending, based on the indication of the acceptance, a notification of the at least one accepted offer to each of the plurality of offers.

12. The method of claim 11, wherein the plurality of offers comprises at least one offer for financing arrangements for a purchase of items.

13. The method of claim 11, wherein the plurality of offers comprises at least one offer to pay for at least part of a purchase of items.

14. The method of claim 11, wherein the plurality of offers comprises at least one of:
a plurality of financing arrangements for a purchase of items comprising respective offers of financing arrangements from a respective plurality of offerors;
a plurality of offers to pay for at least part of a purchase of items comprising respective offers to pay from a respective plurality of offerors; and
a plurality of purchasing incentives comprising respective purchasing incentives from a respective plurality of offerors.

15. The method of claim 11, wherein the plurality of offers comprises a combination of at least two of:
at least one financing arrangement for a purchase of items;
at least one offer to pay for at least part of a purchase of items; and
at least one purchasing incentive.

16. The method of claim 11, further comprising sending, based on the indication of the acceptance, a further notification describing each offer within the plurality of offers.

17. The method of claim 11, wherein the list of items comprises indicated items in which the shopper indicated an interest based on looking at the indicated items.

18. The method of claim 11, wherein the list of items is received during one of:
while shopping in a retailer during the present shopping visit and prior to starting a checkout process, or
during a checkout process.

19. The method of claim 11, wherein the request further comprises an indication of an identification of the shopper.

20. A processor, comprising:
a data transceiver that when operating:
receives, from a shopper's device associated with a shopper during a present shopping visit, a request for offers comprising a list of items in which the shopper indicated an interest during the present shopping visit and an indication of an identification of the shopper; and
a request processor that when operating:
evaluates, based on the indication of the identification, at least one characteristic of the shopper, the at least one characteristic being associated with a definition of an offer to extend to the shopper; and
determines, based on at least one item listed in the list of items and based on the evaluating, at least one offer to extend to the shopper, the at least one offer being conditioned upon a specified purchase to be made during the present shopping visit, the specified purchase being associated with at least one item within the list of items, and
wherein the data transceiver further, when operating, sends, based on determining at least one offer, the at least one offer to the shopper's device associated with the shopper, the at least one offer is valid during the present shopping visit.
